(19) United States
(12) Patent Application Publication
(10) Pub. No.: US 2022/0083947 A1
(43) Pub. Date: Mar. 17, 2022

(54) INFORMATION PROCESSING DEVICE AND PROGRAM

(71) Applicant: TOSHIBA TEC KABUSHIKI KAISHA, Tokyo (JP)

(72) Inventor: Masachika KURATA, Sunto Shizuoka (JP)

(73) Assignee: TOSHIBA TEC KABUSHIKI KAISHA, Tokyo (JP)

(21) Appl. No.: 17/330,696

(22) Filed: May 26, 2021

(30) Foreign Application Priority Data
Sep. 16, 2020 (JP) 2020-155788

(51) Int. Cl. G06Q 10/06; G06T 7/70; G06K 9/00

(52) U.S. Cl. CPC G06Q 10/06398; G06T 7/70; G06T 2207/30232; G06Q 10/06393; G06T 2207/30196; G06K 9/00342

(57) ABSTRACT

An information processing device includes a processor configured to identify, based on a captured image obtained by an imaging device that images a predetermined area, a worker present in the area, and recognize, based on the captured image, an action of the worker identified. The processor is further configured to record, if the action recognized is predetermined work content, correlating with identification information for identifying the worker, a work achievement including a type of the work content and information indicating a date and time when work of the work content was performed and recording the work achievement, and output information based on the work achievement recorded.

### CROSS-REFERENCE TO RELATED APPLICATION

This application is based upon and claims the benefit of priority from Japanese Patent Application No. 2020-155788, filed on Sep. 16, 2020, the entire contents of which are incorporated herein by reference.

### FIELD

Embodiments described herein relate generally to an information processing device and a program.

### BACKGROUND

A plurality of workers work in a workshop such as a food processing factory or a plant factory. A difference in workloads occurs among the workers according to, for example, whether the workers are accustomed to work or suitable for the work content. Accordingly, work achievements of the workers are acquired from the viewpoint of improvement of work efficiency.

For example, a technique for acquiring activities of a worker has been proposed as sensing data with various sensors attached to the worker and analyzing the sensing data to calculate a performance index for work content (e.g., an element of work) achieved by the activities of the worker.

However, in the related art, since the sensors are attached to the worker in order to measure the activities of the worker, the worker feels discomfort. Moreover, a configuration of the technique is complicated. Since the technique is a burden to a factory in terms of cost, there is room for improvement from the viewpoint of efficiency.

Related art is described in, for example, JP-A-2020-35331.

### DESCRIPTION OF THE DRAWINGS

FIG. 1 is a diagram illustrating a configuration example of a worker management system according to at least one embodiment;

FIG. 2 is a diagram illustrating an example of a hardware configuration of an information processing device according to at least one embodiment;

FIG. 3 is a diagram illustrating an example of a data configuration of a worker management table according to at least one embodiment;

FIG. 4 is a diagram illustrating an example of an achievement management table according to at least one embodiment;

FIG. 5 is a diagram illustrating a functional configuration of the information processing device;

FIG. 6 is a diagram illustrating an example of a work achievement output by a work-achievement output unit according to at least one embodiment;

FIG. 7 is a flowchart illustrating an example of processing executed by the information processing device; and

FIG. 8 is a flowchart illustrating an example of action recognition processing executed by the information processing device.

### DETAILED DESCRIPTION

At least one embodiment includes an information processing device and a program capable of efficiently acquiring a work achievement of work content performed by a worker so as to address the aforementioned issues.

An information processing device according to at least one embodiment includes specifying means (e.g., identifying means), recognizing means, recording means, and output means. The specifying means specifies (e.g., identifies), based on a captured image obtained by an imaging device that images a predetermined area, a worker present in the area. The recognizing means recognizes, based on the captured image, an action of the worker specified by the specifying means. If the action recognized by the recognizing means is predetermined work content, the recording means correlates, with identification information for identifying the worker specified by the specifying means, a work achievement including a type of the work content and information indicating a date and time when work of the work content was performed and records the work achievement. The output means outputs information based on the work achievement recorded by the recording means.

An information processing device and a program according to at least one embodiment are explained in detail below. In at least one embodiment explained below, the information processing device and the program are applied to a manufacturing factory such as a food processing factory or a plant factory.

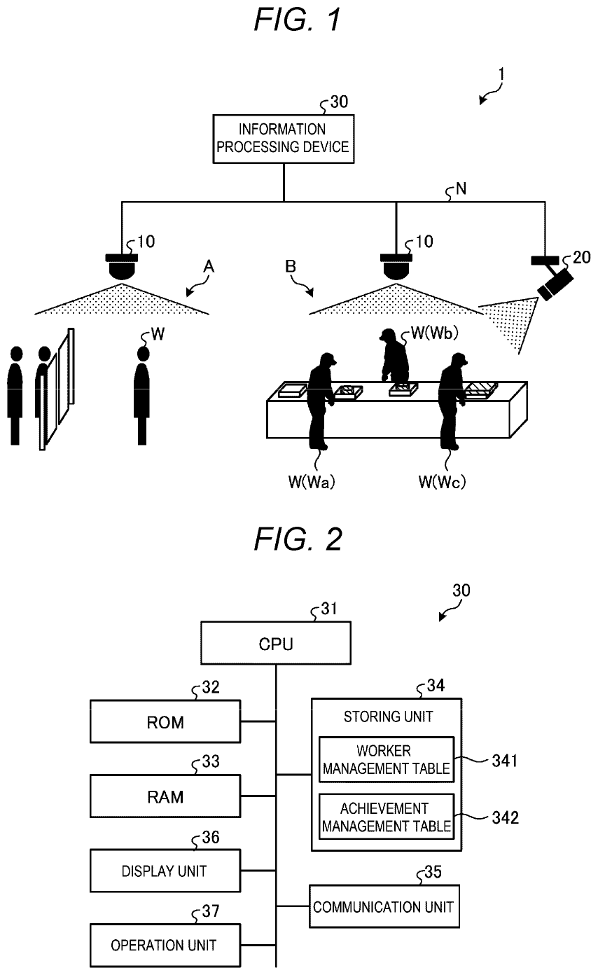

FIG. 1 is a diagram illustrating a configuration example of a worker management system according to at least one embodiment. As illustrated in FIG. 1, a worker management system 1 includes a first imaging device 10, a second imaging device 20, and an information processing device 30. The first imaging device 10 and the second imaging device 20 are communicably connected to the information processing device 30 via a wired or wireless network N.

The first imaging device 10 is an imaging device including an image sensor such as a CCD (Charge Coupled Device). One or a plurality of first imaging devices 10 are set on a ceiling or the like in a factory. The plurality of first imaging devices 10 are provided in, for example, a position where an entrance A in the factory can be imaged and a position where a workshop B can be imaged. The first imaging devices 10 output captured images obtained by the imaging (hereinafter referred to as first captured image as well) to the information processing device 30. The first imaging devices 10 can be realized by, for example, monitoring cameras provided in the factory. In at least one embodiment, the first captured images are mainly used to specify individuals and positions of workers W. The first captured images may be still images or may be moving images.

The second imaging device 20 is an imaging device including an image sensor such as a CCD. One or a plurality of second imaging devices 20 are provided on the ceiling or the like in the factory. The second imaging device 20 is provided in a position where at least the workshop B can be imaged. The second imaging device 20 outputs a captured image obtained by the imaging (hereinafter referred to as second captured image as well) to the information processing device 30. More specifically, the second imaging device 20 is provided in a position where the workers W working in the workshop B can be imaged. In at least one embodiment, the second captured image is mainly used to recognize actions (work contents) performed by the workers W. The workshop B is an example of the predetermined area. The second captured image may be a still image or may be a moving image.

The first imaging device 10 and the second imaging device 20 may be imaging devices having the same configuration. The first imaging device 10 and the second imaging device 20 may be realized by the same imaging device.

The first imaging device 10 and the second imaging device 20 may be imaging devices having different configurations. In this case, the second imaging device 20 may include an imaging function capable of measuring three-dimensional information such as a TOF (Time Of Flight) camera instead of (or together with) a visible light camera such as a CCD. The second imaging device 20 may be configured to be capable of adjusting an imaging direction and an imaging range under control by the information processing device 30.

The information processing device 30 is an example of the information processing device in at least one embodiment. The information processing device 30 is realized by an information processing device such as a PC (Personal Computer) or a server device. The information processing device 30 may be provided in the factory or may be provided in a data center or the like outside the factory.

The information processing device 30 records actions of the workers W based on the captured images (the first captured image and the second captured image) captured by the first imaging device 10 and the second imaging device 20. Specifically, the information processing device 30 specifies, based on the first captured image captured by the first imaging device 10, individuals of the workers W present in the factory and positions of the workers W in the factory. The information processing device 30 recognizes actions (work contents) of the workers W based on the second captured image captured by the second imaging device 20 and records a recognition result.

The worker management system 1 is not limited to the configuration illustrated in FIG. 1. For example, the worker management system 1 may include, around the entrance A, a device (for example, a biological information reading device, an RFID reader, or a code reader) relating to authentication processing for the workers W explained below.

The configuration of the information processing device 30 explained above is explained below.

FIG. 2 is a diagram illustrating an example of a hardware configuration of the information processing device 30. As illustrated in FIG. 2, the information processing device 30 includes a CPU (Central Processing Unit) 31, a ROM (Read Only Memory) 32, a RAM (Random Access Memory) 33, a storing unit 34 (e.g., a memory), a communication unit 35 (e.g., a communication device), a display unit 36 (e.g., a display device, a display), and an operation unit 37. The units configuring the information processing device 30 are connected to the CPU 31 via a bus or the like.

The CPU 31 is an example of a processor and collectively controls the units of the information processing device 30. The ROM 32 stores various programs. The RAM 33 is a work space in which programs and various data are loaded. The CPU 31, the ROM 32, and the RAM 33 realize a computer configuration of the information processing device 30 and function as a control unit (e.g., a controller) of the information processing device 30.

The storing unit 34 is a storage device such as a HDD (Hard Disk Drive) or a flash memory. The storing unit 34 stores a program to be executed by the CPU 31 and setting information and the like relating to the execution of the program.

The storing unit 34 stores a worker management table 341 for retaining information concerning the workers W and an achievement management table 342 for retaining work achievement of the workers W.

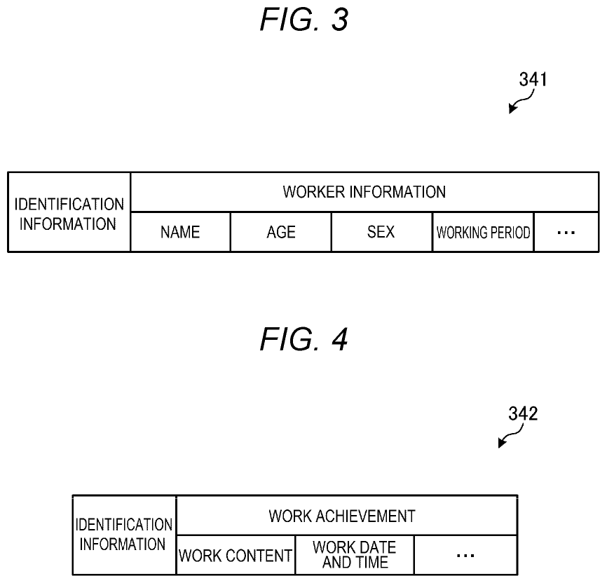

FIG. 3 is a diagram illustrating an example of a data configuration of the worker management table 341. As illustrated in FIG. 3, the worker management table 341 correlates, with identification information of the workers W, worker information including names, ages, sex, and working periods of the workers W and stores the worker information.

The identification information is information capable of uniquely identifying (specifying) each of the workers W. The identification information may be, for example, biological information such as a face image and a fingerprint gathered from each of the workers W. The identification information may be a unique ID (for example, an employee number, a sign, or a mark) allocated to each of the workers W in advance. The names, the ages, and the sex are information indicating names, ages, and sex of the workers W. The working periods are information indicating periods in which the workers W work in the factory. The working periods may be represented in units of years or may be represented in units of months, days, or hours.

The worker management table 341 is not limited to the data configuration illustrated in FIG. 3. For example, the worker management table 341 may include, in the worker information, information indicating titles of the workers W, the workshop B that the workers W are in charge of, types of work contents that the workers W are in charge of, and the like and store the information.

FIG. 4 is a diagram illustrating an example of a data configuration of the achievement management table 342. As illustrated in FIG. 4, the achievement management table 342 correlates, with identification information of the workers W, work achievement information including work content and a work date and time and stores the work achievement information.

The work content is information indicating types of work performed by the workers W. The work content can also be defined as information for identifying each of work processes in a series of work processes relating to manufacturing of foods and the like. For example, if foods such as box lunches are manufactured, each of a series of work such as cooking, dishing up, packing, labeling of price tags or the like, and inspection can be the work content. Classifications of the work content can be optionally set.

The work date and time is information indicating a date and time (year, month, day, hour, minute, second, and the like) when the work was performed. In the work date and time, for example, information indicating a date and time when the work was started and a date and time when the work was completed is recorded. In at least one embodiment, every time work specified by the work content is completed, work achievement information including a work date and time of the work is individually recorded. For example, if the work content is “dishing up”, the work achievement information is recorded every time dishing up work for one box lunch is completed. With such a configuration, in the achievement management table 342, it is possible to derive, for each work content and each worker W, the number of times of work performed within a predetermined period such as one hour.

The achievement management table 342 is not limited to the data configuration illustrated in FIG. 4. For example, the achievement management table 342 may be configured to include, in the work achievement information, for example, information indicating the workshop B where the work is performed and store the information. The achievement management table 342 may be configured to store work achievement information recording, in every unit time, the number of times of work the work specified by the work content is performed.

Referring back to FIG. 2, the communication unit 35 is a communication interface that can be connected to the network N. The communication unit 35 is connected to the network N to transmit and receive various kinds of information to and from external devices such as the first imaging device 10 and the second imaging device 20 connected to the network N.

The display unit 36 is a display device such as a liquid crystal display. The display unit 36 displays various kinds of information under control by the CPU 31. The operation unit 37 is an input device such as a keyboard or a touch key. The operation unit 37 receives operation from an operator and outputs information indicating content of the received operation to the CPU 31. The operation unit 37 may be a touch panel provided on a display screen of the display unit 36.

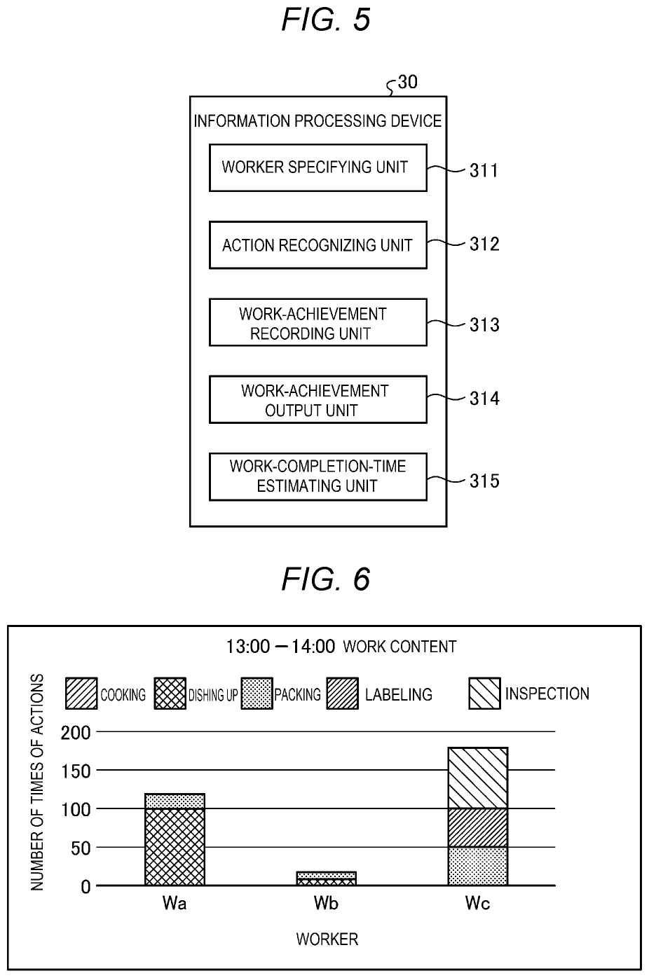

A functional configuration of the information processing device 30 is explained. FIG. 5 is a diagram illustrating an example of the functional configuration of the information processing device 30.

As illustrated in FIG. 5, the information processing device 30 includes, as functional units, a worker specifying unit 311, an action recognizing unit 312, a work-achievement recording unit 313, a work-achievement output unit 314, and a work-completion-time estimating unit 315.

A part or all of the functional units of the information processing device 30 explained above may be a software configuration realized by cooperation of a processor (for example, the CPU 31) of the information processing device 30 and a program stored in a memory (for example, the ROM 32 or the storing unit 34) of the information processing device 30. A part or all of the functional units of the information processing device 30 may be a hardware configuration realized by a dedicated circuit or the like mounted on the information processing device 30.

The worker specifying unit 311 is an example of the specifying means. The worker specifying unit 311 executes processing for specifying individuals of the workers W present in the factory (hereinafter referred to as authentication processing as well).

Specifically, the worker specifying unit 311 performs, based on the identification information of the workers W stored in the worker management table 341, authentication processing for specifying the workers W who enter the factory. A method of the authentication processing does not particularly matter. Various methods can be adopted.

For example, if a reading device that reads biological information such as face images or fingerprints from the workers W is provided around the entrance A, the worker specifying unit 311 may specify, using the biological information read by the reading device, the workers W who enter the factory. In this case, the worker specifying unit 311 retrieves, from the worker management table 341, identification information (biological information) matching the biological information read by the reading device to specify the workers W.

For example, if a reading device that reads IDs from media such as worker certificates or employee certificates distributed to the workers W in advance is provided around the entrance A, the worker specifying unit 311 may specify, using the IDs read by the reading device, the workers W who enter the factory. In this case, the worker specifying unit 311 retrieves, from the worker management table 341, identification information (IDs) matching the IDs read by the reading device to specify the workers W. In this case, the IDs may be retained in the media in a form of electronic tags or may be retained in the media in a form of code symbols such as barcodes.

For example, if IDs (signs, marks, or the like) capable of specifying the workers W are attached to working clothes of the workers W, the worker specifying unit 311 may specify the workers W using IDs read from the captured images captured by the first imaging device 10 and the second imaging device 20. In this case, the worker specifying unit 311 recognizes the IDs included in the captured images and retrieves identification information matching the IDs from the identification information (IDs) of the workers W stored in the worker management table 341 to specify worker information.

The worker specifying unit 311 executes processing for specifying positions of the workers W in the factory (hereinafter referred to as position specifying processing as well).

Basically, the worker specifying unit 311 detects an image representing the workers W (hereinafter referred to as worker image as well) from the captured images captured by the first imaging device 10 and the second imaging device 20 to specify positions in the factory where the workers W are present. A relation between imaging ranges of the first imaging device 10 and the second imaging device 20 and positions (for example, the entrance A and the workshop B) in the factory present within the imaging ranges is stored in the storing unit 34 or the like in advance in a form of, for example, map information.

The worker specifying unit 311 correlates the identification information of the workers W (or the worker information) specified in the authentication processing with the positions in the factory specified in the position specifying processing and manages the identification information. Consequently, it is possible to specify in which positions in the factory the workers W specified by the identification information are present.

For example, if performing the authentication processing using the reading device provided in the entrance A, the worker specifying unit 311 executes processing for associating, from the first captured image of the first imaging device 10 that images the periphery of the entrance A, a worker image of the worker W present in the entrance A and the identification information of the worker W specified in the authentication processing. The worker specifying unit 311 tracks a movement of the worker image associated with the identification information in the captured image and among captured images to specify positions of the worker W in the factory.

For example, if reading an ID attached to the working clothes of the worker W and performing the authentication processing, the worker specifying unit 311 executes processing for, if reading an ID from a captured image, associating the identification information of the worker W specified in the authentication processing with a worker image in a position of the reading. The worker specifying unit 311 tracks a movement of the worker image associated with the identification information in a captured image and among captured images to specify positions of the worker W in the factory.

In this way, the worker specifying unit 311 specifies, based on the captured images captured by the first imaging device 10 and the second imaging device 20, the positions of the workers W present in the factory. As a technique relating to the recognition of the worker image and the tracking of the worker image, a publicly-known technique can be used.

The action recognizing unit 312 is an example of the recognizing means. The action recognizing unit 312 executes action recognition processing for recognizing actions of the workers W specified by the worker specifying unit 311. Specifically, the action recognizing unit 312 sets, based on the positions of the workers W specified by the worker specifying unit 311, the workers W present in the workshop B as recognition targets. Subsequently, the action recognizing unit 312 analyzes the second captured image (the worker image) captured by the second imaging device 20 to recognize actions performed by the workers W in the workshop B, that is, work contents.

An analyzing method for the second captured image does not particularly matter. A publicly-known method can be adopted. For example, the action recognizing unit 312 may analyze the second captured image using a learning model obtained by machine-learning, with deep learning or the like, motions of the workers W relating to various work contents. In this case, if the second captured image is input, the learning model outputs a result of inference about whether the workers W (the worker image) represented by the second captured image are performing specified work contents. The action recognizing unit 312 recognizes, as work contents performed by the workers W, the inference result output by the learning model.

As an example, if recognition target work relates to manufacturing of foods such as box lunches, the information processing device 30 stores, in advance, about each of the work contents such as cooking, dishing up, packing, labeling of price tags or the like, and inspection explained above, in the storing unit 34 or the like, a learning model obtained by machine-learning motions and postures of the workers W in executing the work contents, states before and after work for work target foods, and the like. In this case, if the second captured image is input, the learning model outputs a result of inferring, from the motions and the postures of the workers W (the worker image) represented by the second captured image, the states of the work target foods, and the like, types of work contents performed by the workers W and execution states (start, completion, and the like of work) of the work contents. The action recognizing unit 312 recognizes actions of the recognition target workers W based on the inference result obtained by inputting the second captured image to the learning model.

The learning model is stored in advance but may be generated by the information processing device 30 or may be generated by another device. A method of the action recognition processing is not limited to the method of recognizing actions using the learning model and may be a method of recognizing actions using another method such as pattern recognition.

The work-achievement recording unit 313 is an example of the recording means. The work-achievement recording unit 313 records work achievements of the workers W based on a recognition result of the action recognizing unit 312. Specifically, the work-achievement recording unit 313 correlates, with identification information of the recognition target workers W, work achievements including types of work contents recognized by the work recognizing unit 312 and date and times when the work contents were performed, and stores (registers) the work achievements in the achievement management table 342. For example, every time dishing up work is recognized as work content by the action recognizing unit 312, the work-achievement recording unit 313 individually stores a work achievement including, as a work date and time, a date and time when the dishing up work was performed.

The work-achievement output unit 314 is an example of the output means. The work-achievement output unit 314 outputs information based on the work achievements stored in the achievement management table 342. For example, the work-achievement output unit 314 causes the display unit 36 to display the work achievements stored in the achievement management table 342. The work-achievement output unit 314 transmits the work achievements stored in the achievement management table 342 to a not-illustrated external device via the communication unit 35. The work-achievement output unit 314 prints and outputs the work achievements stored in the achievement management table 342 from a not-illustrated printer device.

An output form of the work achievements does not particularly matter. The work achievements can be output in various forms. For example, for each specific worker W or worker W, the work-achievement output unit 314 outputs, in a visualized state, the number of times for each type of work contents performed in a predetermined period (for example, in one month, one day, or one hour). The predetermined period may be designated via the operation unit 37 or may be set in advance. A method of visualization does not particularly matter and may be graphing as, for example, a stacked type bar graph (see FIG. 6) explained below or a display method in a table format or the like.

As illustrated in FIG. 6, the work-achievement output unit 314 may output work achievements of a plurality of workers W in the predetermined period in a comparable state.

FIG. 6 is a diagram illustrating an example of work achievements output by the work-achievement output unit 314. In FIG. 6, a cumulative value of the numbers of times of execution (the numbers of times of actions) of work contents performed by each of workers Wa, Wb, and Wc (see FIG. 1) from 13:00 to 14:00 is represented by a stacked type bar graph. The cumulative value of the numbers of times of execution is a concept corresponding to a workload.

An output result illustrated in FIG. 6 indicates that the worker Wa performed the dishing up work one hundred times and performed the packing work twenty times in one hour from 13:00 to 14:00. The output result illustrated in FIG. 6 indicates that the worker Wb performed the dishing up work ten times and performed the packing work ten times in one hour from 13:00 to 14:00. The output result illustrated in FIG. 6 indicates that the worker Wc performed the dishing up work fifty times, performed the cooking work fifty times, and performed the inspection work eighty times in one hour from 13:00 to 14:00.

In this way, the work-achievement output unit 314 outputs, in a visualized state, the work achievements of the workers W recorded in the achievement management table 342. Consequently, a user who manages the factory can easily confirm, by viewing the output result of the work-achievement output unit 314, a workload for each work content performed by each of the workers W and a difference in the workload. The user can use, as indicators for a combination of the workers W assigned to the same workshop B, allocation of work contents assumed by the workers W, and the like. Therefore, the information processing device 30 can contribute to improvement of work efficiency.

An output form of the work achievements output by the work-achievement output unit 314 is not limited to the example illustrated in FIG. 6. For example, the work-achievement output unit 314 may read out the ages, the working period, and the like from the worker information of the workers W (the identification information) stored in the worker management table 341 and correlate the ages, the working periods, and the like with work achievements and stacked type bar graphs corresponding to the ages, the working periods, and the like and output (display) the ages, the working periods, and the like.

In this case, the user who manages the factory can easily confirm a relation between proficiency levels and workloads of the workers W by viewing the output result of the work-achievement output unit 314. The user can use the output result of the work-achievement output unit 314 as indicators for a combination of the workers W assigned to the same workshop B, allocation of work contents assumed by the workers W, and the like. Therefore, the information processing device 30 can contribute to improved work efficiency.

In at least one embodiment, the timing of when the work-achievement output unit 314 outputs the work achievement does not particularly matter and may be optionally set. For example, the work-achievement output unit 314 may start the output of the work achievements according to operation via the operation unit 37 or may start the output at preset timing.

The work-completion-time estimating unit 315 is an example of the calculating means and the estimating means. The work-completion-time estimating unit 315 calculates, based on the work achievements stored in the achievement management table 342, for each type of work contents, the numbers of times of work per unit time of the workers W. The work-completion-time estimating unit 315 estimates, based on the calculated numbers of times of work per unit time of the workers W, as a work completion time, a time required by each of the specific workers W or the workers W to process designated work content and a designated workload.

Specifically, if conditions for designating an estimation target work content, an estimation target workload, an estimation target worker W, and the like are input, the work-completion-time estimating unit 315 calculates, referring to the achievement management table 342 for a work achievement of the designated worker W, the number of times of actions (the number of times of work) per unit time (for example, one hour) of the estimation target work content. Subsequently, the work-completion-time estimating unit 315 divides the estimation target work load by the calculated number of times of actions per unit time to estimate a work completion time.

For example, if the estimation target work content is the dishing up work and the estimation target worker W is the worker Wa, the work-completion-time estimating unit 315 calculates the number of times of work per one hour, 100 (times/hour), based on the work achievements illustrated in FIG. 6. If the estimation target workload is 300, the work-completion-time estimating unit 315 estimates, as a work completion time, “3 hours” obtained by dividing the workload by 100.

An estimation method for the work completion time is not limited to the example explained above. For example, the estimation target work content may be a plurality of work contents. A plurality of workers W may be designated.

The estimation target work content and the estimation target workload may be specified in work unit obtained by integrating a series of work contents. For example, if a series of work contents relating to manufacturing of box lunches are configured by cooking, dishing up (plating), packing, labeling, and inspection, box lunch manufacturing work obtained by integrating these work contents may be set as the estimation target work content and the number of box lunches planned to be manufactured (for example, two hundred) may be set as the workload. In this case, the work-completion-time estimating unit 315 estimates a work completion time in the case in which the designated worker W processes the work contents of cooking, dishing up, packing, labeling, and inspection by the estimation target workload.

In this case, the work-completion-time estimating unit 315 performs the estimation of the work completion time according to a method corresponding to the number of designated workers W.

For example, if one worker W is designated, the work-completion-time estimating unit 315 calculates, based on the work achievements stored in the achievement management table 342, the numbers of times of actions per unit time of the designated worker W respectively in performing the work contents such as cooking and dishing up. The work-completion-time estimating unit 315 adds up times obtained by dividing the workloads of the work contents by the numbers of times of actions per unit time and estimates a result of the addition as a work completion time.

For example, if a plurality of workers W are designated, the work-completion-time estimating unit 315 calculates, based on the work achievements stored in the achievement management table 342, the numbers of times of actions per unit time of the designated workers W respectively in performing the work contents such as cooking and dishing up. Subsequently, the work-completion-time estimating unit 315 allocates, based on the calculated numbers of times of actions per unit time, the work contents to the designated workers W. The work-completion-time estimating unit 315 sums times obtained by dividing the workloads of the work contents allocated to the workers W by the numbers of times of actions per unit time of the workers W and estimates a result of the addition as work completion times.

An allocation method for the work contents does not particularly matter. Any method can be adopted. For example, the work-completion-time estimating unit 315 may assign the workers W to work contents having larger numbers of times of actions per unit time. The work-completion-time estimating unit 315 may execute, in all combinations, allocation of the work contents to the designated workers W to estimate a maximum value and a minimum value of the work completion times. The work-completion-time estimating unit 315 may derive, together with the work completion times, a combination of the worker W and work content that minimizes the work completion times.

Timing when the work-completion-time estimating unit 315 estimates the work completion times does not particularly matter and can be optionally set. For example, if the conditions explained above are input via the operation unit 37, the work-completion-time estimating unit 315 may start the estimation of the work completion times.

The numbers of times of actions per unit time calculated by the work-completion-time estimating unit 315 and an estimation result of the work completion times by the work-completion-time estimating unit 315 may be output to the display unit 36, the external device, and the like by the work-achievement output unit 314.

For example, the work-achievement output unit 314 outputs, for each worker W, the numbers of times of actions per unit time calculated by the work-completion-time estimating unit 315 and outputs the numbers of times of actions in a state in which the numbers of times of actions can be compared among the plurality of workers W. For example, the work-achievement output unit 314 outputs, for each worker W, the work completion times estimated by work-completion-time estimating unit 315 and outputs the work completion times in a state in which the work completion times can be compared among the plurality of workers W. A display form of the numbers of times of actions per unit time and the work completion times does not particularly matter. For example, like the work achievements explained above, the work-achievement output unit 314 may read out the ages, the working periods, and the like from the worker information of the workers W (the identification information) stored in the worker management table 341 and display the ages, the working periods, and the like together with the numbers of times of actions per unit time and the work completion times.

With the function of the work-completion-time estimating unit 315, for example, the user who manages the factory can obtain the work completion times by inputting work contents and workloads of a work schedule to the information processing device 30 together with the identification information and the like for designating the workers W. Consequently, the information processing device 30 can support selection work for the worker W to which work is allocated, selection work for work contents allocated to the workers W, and the like. Therefore, the information processing device 30 can contribute to improvement of work efficiency.

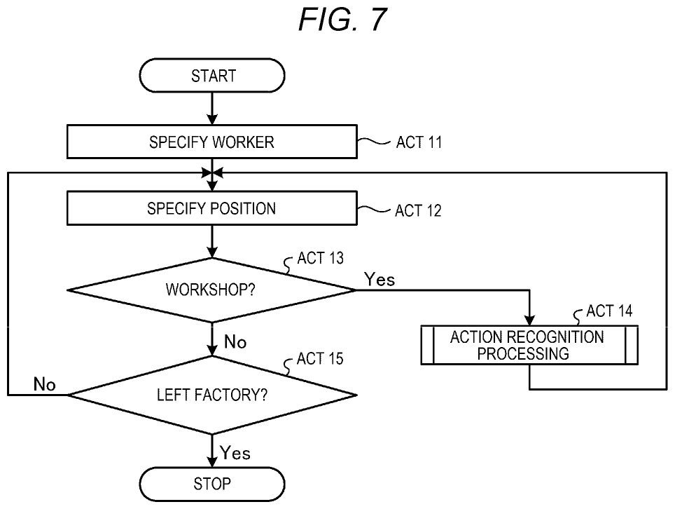

An operation example of the information processing device 30 explained above is explained. FIG. 7 is a flowchart illustrating an example of processing executed by the information processing device 30.

First, the worker specifying unit 311 executes, based on captured images captured by a not-illustrated authentication device or the first imaging device 10 and the second imaging device 20, authentication processing for specifying individuals of workers present in the factory (ACT 11).

Subsequently, the worker specifying unit 311 associates identification information of the workers specified in ACT 11 with a worker image included in the captured images photographed by the first imaging device 10 and the second imaging device 20 to specify the positions of the workers present in the factory (ACT 12).

Subsequently, the action recognizing unit 312 determines, as to each of the workers specified in ACT 12, whether the worker is present in the workshop B (ACT 13). About the worker present in the workshop B, the action recognizing unit 312 executes action recognition processing for recognizing an action of the worker (ACT 14).

On the other hand, concerning the worker W absent in the workshop B, the action recognizing unit 312 determines, based on a position in the factory specified by the worker specifying unit 311, whether the worker W left the factory (ACT 15). For example, if the position of the worker W specified by the worker specifying unit 311 disappeared halfway, the action recognizing unit 312 determines that the worker W left the factory. If determining that the worker W left the factory (Yes in ACT 15), the action recognizing unit 312 ends the processing about the relevant worker W. If the position of the worker W specified by the worker specifying unit 311 is present in a place other than the workshop B, the action recognizing unit 312 determines that the worker W is present in the factory (No in ACT 15) and returns the processing to ACT 12.

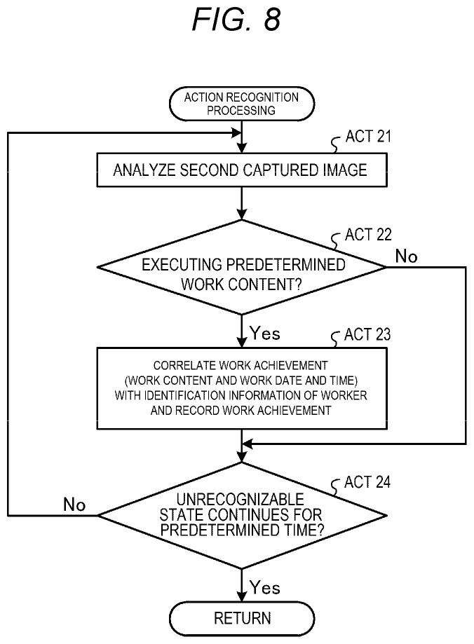

FIG. 8 is a flowchart illustrating an example of action recognition processing executed by the information processing device 30. This processing corresponds to the processing in ACT 14 in FIG. 7 explained above.

First, the action recognizing unit 312 analyzes the second captured image obtained by imaging the workshop B and recognizes an action of the worker W represented by the second captured image (ACT 21). Specifically, the action recognizing unit 312 inputs the second captured image to the learning model to recognize the action of the worker W represented by the second captured image.

Subsequently, the action recognizing unit 312 determines whether the worker W is executing predetermined work content (ACT 22). If the recognized action of the worker W is other than the predetermined work content, for example, if failing in recognizing the action itself, the action recognizing unit 312 determines that work is not performed (No in ACT 22) and shifts to ACT 24.

On the other hand, if the action of the worker W recognized by the action recognizing unit 312 is the predetermined work content (Yes in ACT 22), the work-achievement recording unit 313 correlates a work achievement including a type and a work date and time of the recognized work content with identification information of the worker W and records the work achievement in the achievement management table 342 (ACT 23) and shifts to ACT 24.

In subsequent ACT 24, the action recognizing unit 312 determines whether a state in which the action of the worker W cannot be recognized (hereinafter referred to as unrecognizable state as well) continued for a predetermined time (for example, for three minutes) (ACT 24). If the unrecognizable state continued for less than the predetermined time (No in ACT 24), the action recognizing unit 312 returns the processing to ACT 21. If the unrecognizable state continued for the predetermined time or more (Yes in ACT 24), the action recognizing unit 312 returns the processing to ACT 12 in FIG. 7.

As explained above, the information processing device 30 in at least one embodiment specifies, based on the captured image obtained by imaging the workshop B, the worker W present in the workshop B and recognizes an action of the specified worker W. If the recognized action of the worker W is the predetermined work content, the information processing device 30 correlates, with the identification information of the worker W, a work achievement including a type of the work content and information indicating a date and time when work of the work content was performed and records the work achievement in the achievement management table 342. The information processing device 30 outputs information based on the work achievement recorded in the achievement management table 342.

Consequently, the information processing device 30 can recognize, from the captured image obtained by imaging the workshop B, actions of the workers W present in the workshop B and record achievements of work contents performed by the workers W as work achievements. Therefore, the information processing device 30 can efficiently acquire the work achievements of the workers W. The information processing device 30 can acquire the work achievements of the workers W without using a special sensing device. Therefore, the information processing device 30 can reduce a load applied to the workers W and a load in terms of cost. The information processing device 30 can output information based on the acquired work achievements. Therefore, the information processing device 30 can contribute to improvement of work efficiency.

At least one embodiment explained above can also be modified as appropriate and implemented by changing a part of the components or the functions of the devices explained above. Therefore, in the following explanation, several modifications relating to at least one embodiment explained above are explained as other embodiments. In the following explanation, differences from at least one embodiment explained above are mainly explained. Detailed explanation is omitted about similarities to the contents explained above. The modifications explained below may be individually implemented or may be implemented in combination as appropriate.

Modification 1

In at least one embodiment explained above, the workers working in the factory are the management targets. However, workers working in places other than the factory may be the management targets. A place (a predetermined area) imaged by the second imaging device 20 is not limited to the workshop. The second imaging device 20 may image a specific place such as a desk or may image an entire facility.

The program executed by the information processing device 30 in at least one embodiment explained above is provided in a state in which the program is incorporated in the ROM 32, the storing unit 34, or the like in advance. The program executed by the information processing device 30 in at least one embodiment may be provided while being recorded in a computer-readable recording medium such as a CD-ROM, a flexible disk (FD), a CD-R, or a DVD (Digital Versatile Disk) as a file in an installable format or an executable format.

Further, the program executed by the information processing device 30 in at least one embodiment may be stored on a computer connected to a network such as the Internet and provided by being downloaded through the network. The program executed by the information processing device 30 in at least one embodiment may be provided or distributed through a network such as the Internet.

The embodiments (the modifications) are explained above. However, these embodiments are presented as examples and are not intended to limit the scope of the invention. These embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. An information processing device comprising:
a processor configured to:
identify, based on a captured image obtained by an imaging device that images a predetermined area, a worker present in the predetermined area;
recognize, based on the captured image, an action of the worker identified;
record, if the action recognized is predetermined work content, correlating with identification information for identifying the worker identified, a work achievement including a type of the work content and information indicating a date and time when work of the work content was performed and recording the work achievement; and
output information based on the work achievement recorded.

2. The device of claim 1, wherein the information output based on the work achievement, in a visualized state, is a number of times of each type of the work content performed in a predetermined period.

3. The device of claim 1, wherein the output information is the work achievements of a plurality of the workers in a comparable state.

4. The device of claim 1, wherein the processor is further configured to:
calculate, based on the work achievement, for each type of the work content, a number of times of work per unit time of the worker; and
output a calculation result.

5. The device of claim 4, wherein the processor is further configured to:
estimate, based on the number of times of work per unit time of the worker calculated, as a work completion time, a time required by the worker to process designated work content and a designated workload; and
output an estimation result.

6. The device of claim 1, wherein the imaging device comprises:
a first imaging device positioned to obtain images of an entrance of the predetermined area and the predetermined area, and configured to obtain images to identified the worker and the position of the workers; and
a second imaging device position to obtain images of the predetermined area, and a configured to obtain images to recognize the work content performed by the workers.

7. The device of claim 6, wherein the processor is further configured to associate the identification information of the worker with a worker image included in the captured images by the first imaging device and the second imaging device to identify the positions of the worker present.

8. An information processing method comprising:
identifying, based on a captured image obtained by an imaging device that images a predetermined area, a worker present in the area;
recognizing, based on the captured image, an action of the identified worker;
if the recognized action is predetermined work content, correlating, with identification information of the identified worker, a work achievement including a type of the work content and information indicating a date and time when work of the work content was performed and recording the work achievement; and
outputting information based on the recorded work achievement.

9. The device of claim 8, wherein the information output based on the work achievement, in a visualized state, is a number of times of each type of the work content performed in a predetermined period.

10. The device of claim 8, wherein the output information is the work achievements of a plurality of the workers in a comparable state.

11. The device of claim 8, wherein the processor is further configured to:
calculate, based on the work achievement, for each type of the work content, a number of times of work per unit time of the worker; and
output a calculation result.

12. The device of claim 11, wherein the processor is further configured to:
estimate, based on the number of times of work per unit time of the worker calculated, as a work completion time, a time required by the worker to process designated work content and a designated workload; and
output an estimation result.

13. The device of claim 8, wherein the imaging device comprises:
a first imaging device positioned to obtain images of an entrance of the predetermined area and the predetermined area, and configured to obtain images to identified the worker and the position of the workers; and
a second imaging device position to obtain images of the predetermined area, and configured to obtain images to recognize the work content performed by the workers.

14. The device of claim 13, wherein the processor is further configured to associate the identification information of the worker with a worker image included in the captured images by the first imaging device and the second imaging device to identify the positions of the worker present.
